(19) United States
(12) Patent Application Publication
(10) Pub. No.: US 2025/0191058 A1
(43) Pub. Date: Jun. 12, 2025

(54) INFORMATION PROCESSING APPARATUS, INFORMATION PROCESSING SYSTEM, INFORMATION PROCESSING METHOD, AND NON-TRANSITORY COMPUTER READABLE MEDIUM

(71) Applicant: NEC Corporation, Minato-ku, Tokyo (JP)

(72) Inventor: Taichi OKUMURA, Tokyo (JP)

(73) Assignee: NEC Corporation, Minato-ku, Tokyo (JP)

(21) Appl. No.: 18/843,832

(22) PCT Filed: Mar. 17, 2022
(86) PCT No.: PCT/JP2022/012190

§ 371 Date: Sep. 4, 2024

(51) Int. Cl. G06Q 30/0645; G06F 21/32

(52) U.S. Cl. CPC G06Q 30/0645; G06F 21/32

(57) ABSTRACT

An information processing apparatus includes: a determination unit configured to determine whether or not a return procedure for a mobile body rented by a user has been completed; a specifying unit configured to specify, upon determining by the determination unit that the return procedure has been completed, a return place for the mobile body; and a transmission control unit configured to transmit, to a user terminal used by the user, at least a part of area information regarding an area to which the specified return place belongs, as first transmission information. It is therefore possible to suitably encourage repeated use of a rental service.

### TECHNICAL FIELD

The present disclosure relates to an information processing apparatus, an information processing system, an information processing method, and a non-transitory computer readable medium.

### BACKGROUND ART

In recent years, in view of the spread of bicycles and automobile rental services, methods for promoting the use of rental services have been proposed. For example, Patent Literature 1 discloses a method for transmitting, when a dd user who rents a mobile body stops at a store, information on stores near the store at which the user has stopped to the mobile body, thereby motivating the user to continue using the mobile body that the user has rented.

### CITATION LIST

### Patent Literature

[Patent Literature 1] Japanese Unexamined Patent Application Publication No. 2012-094042

### SUMMARY OF INVENTION

### Technical Problem

While the aforementioned method disclosed in Patent Literature 1 encourages the user to continue to use the rented mobile body, it is required to promote repeated use of the rental service even after the service is ended.

The present disclosure has been made in view of the aforementioned problem, and an object of the present disclosure is to provide an information processing apparatus, an information processing system, an information processing method, and a non-transitory computer readable medium suitably encouraging repeated use of a rental service.

### Solution to Problem

An information processing apparatus according to one aspect of the present disclosure includes: determination means for determining whether or not a return procedure for a mobile body rented by a user has been completed; specifying means for specifying, upon determining that the return procedure has been completed, a return place for the mobile body; and transmission control means for transmitting, to a user terminal used by the user, at least a part of area information regarding an area to which the specified return place belongs as first transmission information.

An information processing system according to one aspect of the present disclosure includes: an information terminal; and an information processing apparatus, in which the information processing apparatus includes: determination means for determining, upon receiving return information including identification information of a mobile body rented by a user from the information terminal, whether or not a return procedure for the mobile body has been completed; specifying means for specifying, upon determining that the return procedure has been completed, a return place for the mobile body; and transmission control means for transmitting, to a user terminal used by the user, at least one of area information regarding an area to which the specified return place belongs as first transmission information.

An information processing method according to one aspect of the present disclosure includes: determining whether or not a return procedure for a mobile body rented by a user has been completed; specifying a return place for the mobile body upon determining that the return procedure has been completed; and transmitting, to a user terminal used by the user, at least a part of area information regarding an area to which the specified return place belongs as first transmission information.

A non-transitory computer readable medium according to one aspect of the present disclosure stores a program for causing a computer to implement: a determination function for determining whether or not a return procedure for a mobile body rented by a user has been completed; a specification function for specifying a return place for the mobile body upon determining that the return procedure has been completed; and a transmission control function configured to transmit, to a user terminal used by the user, at least a part of area information regarding an area to which the specified return place belongs as first transmission information.

### Advantageous Effects of Invention

According to the present disclosure, it is possible to provide an information processing apparatus, an information processing system, an information processing method, and a non-transitory computer readable medium suitably encouraging repeated use of a rental service.

### BRIEF DESCRIPTION OF DRAWINGS

FIG. 1 is a block diagram showing a configuration of an information processing apparatus according to a first example embodiment;

FIG. 2 is a flowchart showing a flow of an information processing method according to the first example embodiment;

FIG. 3 is a block diagram showing a whole configuration of an information processing system according to a second example embodiment;

FIG. 4 is a block diagram showing a configuration of a face authentication apparatus according to the second example embodiment;

FIG. 5 is a flowchart showing a flow of face information registration processing according to the second example embodiment;

FIG. 6 is a flowchart showing a flow of face authentication processing according to the second example embodiment;

FIG. 7 is a block diagram showing a configuration of a user terminal according to the second example embodiment;

FIG. 8 is a block diagram showing a configuration of a store terminal according to the second example embodiment;

FIG. 9 is a block diagram showing a configuration of a server according to the second example embodiment;

FIG. 10 is a sequence diagram showing a flow of member registration processing according to the second example embodiment;

FIG. 11 is a sequence diagram showing a flow of rental start processing according to the second example embodiment;

FIG. 12 is a sequence diagram showing a flow of return processing according to the second example embodiment;

FIG. 13 is a diagram showing one example of display on a user terminal according to the second example embodiment; and

FIG. 14 is a sequence diagram showing a flow of processing for providing second transmission information according to the second example embodiment.

### EXAMPLE EMBODIMENT

Hereinafter, with reference to the drawings, example embodiments of the present disclosure will be described in detail. Throughout the drawings, the same or corresponding elements are denoted by the same reference symbols, and redundant descriptions will be omitted for the sake of clarity of the description.

### First Example Embodiment

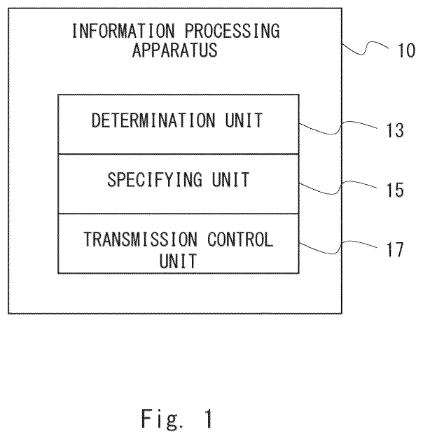

First, a first example embodiment according to the present disclosure will be described. FIG. 1 is a block diagram showing a configuration of an information processing apparatus 10 according to the first example embodiment. The information processing apparatus 10 is formed of one or more computers and provides information on an area for a user who has rented a mobile body. The mobile body is a bicycle, an automobile, an electric cart, or another vehicle that can be rent. The information processing apparatus 10 is connected to a network (not shown). The network may be either a wired network or a wireless network. Further, a user terminal (not shown) used by the user is at least connected to the network.

The information processing apparatus 10 includes a determination unit 13, a specifying unit 15, and a transmission control unit 17.

The determination unit 13 is also referred to as determination means. The determination unit 13 determines whether or not a return procedure for a mobile body rented by a user has been completed. The mobile body rented by the user is a mobile body regarding which a rental start procedure has been completed by the user.

The specifying unit 15 is also referred to as specifying means. The specifying unit 15 specifies, upon determining that the return procedure has been completed, a return place for the mobile body by a predetermined method. Then the specifying unit 15 specifies the area to which the specified return place belongs.

The transmission control unit 17 is also referred to as transmission control means. The transmission control unit 17 transmits, to a user terminal of the user who has completed the return procedure, area information regarding an area to which the specified return place belongs as first transmission information. The area information may be at least one of sales promotion information of stores operating in the area or news of this area. The sales promotion information is discount information, information introducing new products or new services, or other sales promotion information. The news include weather, traffic information, event information or the like. The information processing apparatus 10 stores area information for each area, and the transmission control unit 17 may set the entire area information that is stored as the first transmission information or may set a part thereof as the first transmission information.

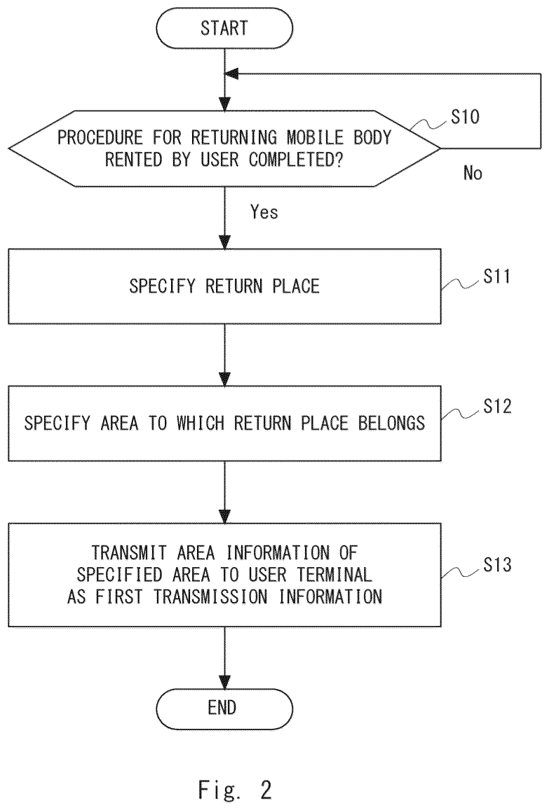

FIG. 2 is a flowchart showing a flow of an information processing method according to the first example embodiment. First, the determination unit 13 of the information processing apparatus 10 determines whether or not the procedure for returning the mobile body rented by the user has been completed (S10). The criteria for determining that the return procedure has been completed may be determined as desired. For example, the determination unit 13 may determine that the return procedure has been completed in response to the user returning the mobile body that he/she has rented to the return place. In a further example, the determination unit 13 may determine that the return procedure has been completed in response to the user paying the usage fee for the rental service. In still another example, the determination unit 13 may determine that the return procedure has been completed in response to the user entering a request for completing the return procedure and successful identification of the user. The determination unit 13 repeats the processing shown in S10 until it is determined that the return procedure has been completed (No in S10).

When the determination unit 13 has determined that the return procedure has been completed (Yes in S10), the specifying unit 15 specifies the return place for the mobile body by a predetermined method (S11). The specifying unit 15 may specify the return place based on, for example, the location information of the mobile body or the location information of the user terminal. Further, the specifying unit 15 may specify the return place when, for example, information indicating that the return has been detected is sent from a terminal installed in the return place, such as a sensor of a tire holder or a settlement machine.

Then the specifying unit 15 specifies the area to which the return place belongs (S12). The specifying unit 15 may specify, for example, an area within a predetermined distance from the return place as the area to which the return place belongs. Further, for example, the specifying unit 15 may specify an area in a local government that manages the return place as the area to which the return place belongs. Further, for example, the specifying unit 15 may specify an area near the station closest to the return place as the area to which the return place belongs.

Then, the transmission control unit 17 transmits the area information of the specified area to the user terminal of the user who has completed the return procedure (S13).

As described above, the information processing apparatus 10 gives an advantage to the user by transmitting the area information to the user terminal of the user who has completed the return procedure. As a result, it is possible to promote repeated use of the rental service. Further, the information processing apparatus 10 may let the user who has completed the return procedure travel around the return place. As a result, it is possible to contribute to revitalization of the local economy.

### Second Example Embodiment

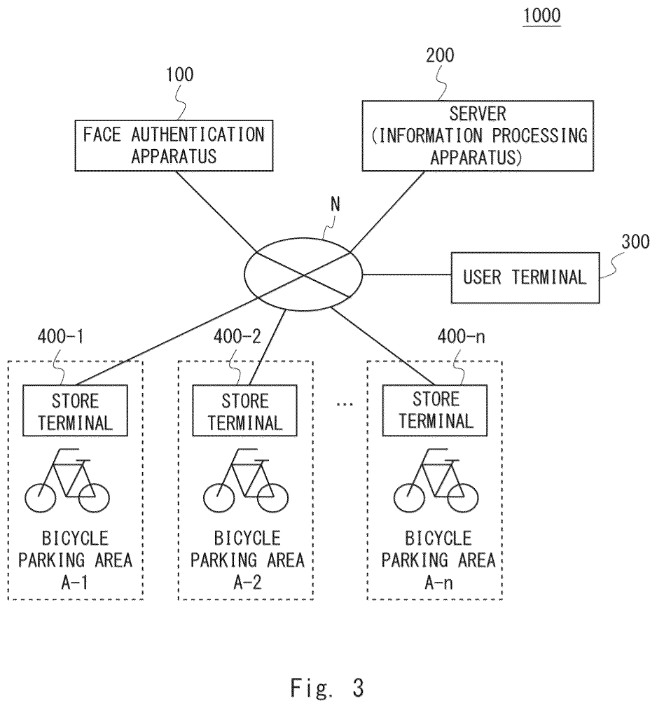

Next, a second example embodiment according to the present disclosure will be described. The second example embodiment is a specific example of the first example embodiment. FIG. 3 is a block diagram showing a whole configuration of an information processing system 1000 according to the second example embodiment. The information processing system 1000 is a system formed of one or more computers for providing a rental service of mobile bodies. In the second example embodiment, a mobile body is, but not particularly limited to, a bicycle.

In the information processing system 1000, a plurality of bicycle parking areas A-1, A-2, . . . and A-n are provided as return places. The user rents a bicycle at any one of bicycle parking areas, travels to a destination with the rented bicycle, and returns the bicycle to a bicycle parking area near the destination.

The information processing system 1000 includes a face authentication apparatus 100, an information processing apparatus (hereinafter it is referred to as a server) 200, a user terminal 300, and one or more store terminals 400. The apparatuses and the terminals are connected to each other via a network N. The network N is a wired or wireless communication line.

The face authentication apparatus 100 is one example of a biometric authentication apparatus that performs biometric authentication based on biometric information. The face authentication apparatus 100 stores face feature information of a plurality of persons. When a member is registered, the face authentication apparatus 100 registers face feature information of the user, as will be described later. At this time, the face authentication apparatus 100 issues a user ID to the user. The user ID, which is information for identifying the user, is, for example, a member number. Further, the face authentication apparatus 100 includes a face authentication function for collating, in accordance with a face authentication request externally received, a face image or face feature information included in the request with face feature information of each user. In the second example embodiment, the face authentication apparatus 100 acquires the face image obtained by capturing the image of the face of the user who has visited the store from the store terminal 400 via the server 200, and executes face authentication using the face image. Then, the face authentication apparatus 100 sends a result of the collation (the result of face authentication) back to the server 200.

The server 200 is one example of the information processing apparatus 10 according to the first example embodiment. The server 200 is a computer that manages information on the user, who is the member, manages a usage status of a bicycle, and provides area information for the user.

The user terminal 300 is a personal computer, a smartphone, a tablet terminal, or another information terminal used by the user. The user registers members using the user terminal 300.

Each of the store terminals 400 is an information terminal installed in each bicycle parking area.

First, the user requests member registration for the server 200 using the user terminal 300. Accordingly, the server 200 registers the user as a member.

When the user visits the bicycle parking area, specifies a bicycle, and requests for a rental start procedure, the store terminal 400 first receives face authentication for the user. In this second example embodiment, the store terminal 400 captures an image of at least a face of the user to be authenticated and transmits a face image or face feature information extracted from this face image to the server 200. The server 200 requests the face authentication apparatus 100 to perform face authentication of the face image of the user or face feature information, and receives a result of face authentication.

When the face authentication of the user has been successful, it is determined in the server 200 that the start procedure has been completed. In this case, the store terminal 400 unlocks a tire holder of a specified bicycle. Accordingly, the user is able to use the specified bicycle.

Further, when the user has set a bicycle tire in a tire holder in a bicycle parking area and has requested a return procedure, the store terminal 400 receives face authentication for the user, like in the start procedure. When the face authentication of the user has been successful, the server 200 settles the usage fee with a face, and then it is determined that the return procedure has been completed.

Then, upon determining that the return procedure has been completed, the server 200 transmits area information of an area near the place where the store terminal 400 that has involved in the return procedure is installed (i.e., a parking place used as a return place) to the user terminal 300 of the user who has completed the return procedure as first transmission information.

Further, the server 200 transmits, to the user terminal 300, area information of the area near the bicycle parking area that the user frequently uses as a return place as second transmission information regardless of the timing when the return procedure is completed.

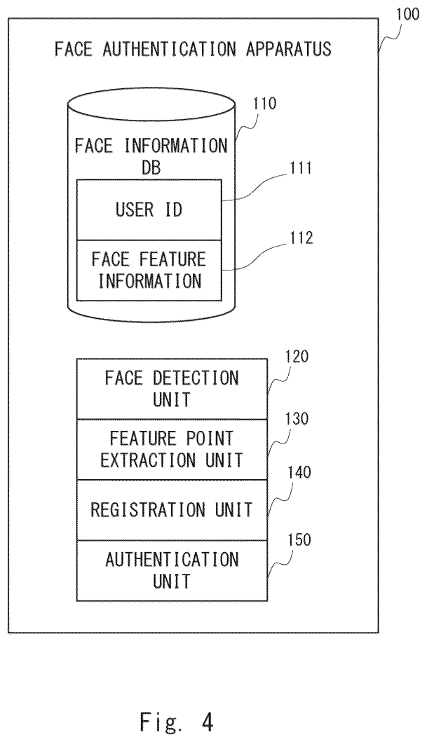

FIG. 4 is a block diagram showing a configuration of the face authentication apparatus 100 according to the second example embodiment. The face authentication apparatus 100 includes a face information DB (DataBase) 110, a face detection unit 120, a feature point extraction unit 130, a registration unit 140, and an authentication unit 150. The face information DB 110 stores a user ID 111 and face feature information 112 on the user in such a way that they are associated with each other. The face feature information 112 is a set of features extracted from a face image. Note that the face authentication apparatus 100 may delete the face feature information 112 in the face feature DB 110 in response to a request from the registered user of the face feature information 112. Alternatively, the face authentication apparatus 100 may delete the face feature information 112 after an elapse of a certain period of time since the face feature information 112 is registered.

The face detection unit 120 detects a face area included in the registered image for registering face feature information, and supplies the detected face area to the feature point extraction unit 130. The feature point extraction unit 130 extracts feature points from the face area detected by the face detection unit 120 and supplies the face feature information to the registration unit 140. Further, the feature point extraction unit 130 extracts feature points included in the face image received from the server 200 and supplies face feature information to the authentication unit 150.

The registration unit 140 newly issues the user ID 111 when the face feature information is registered. The registration unit 140 registers the issued user ID 111 and the face feature information 112 extracted from the registered image in the face information DB 110 in such a way that they are associated with each other. The authentication unit 150 performs face authentication using the face feature information 112. Specifically, the authentication unit 150 collates the face feature information extracted from the face image with the face feature information 112 in the face information DB 110. The authentication unit 150 sends information indicating whether the two pieces of face feature information match each other back to the server 200. The information indicating whether the two pieces of face feature information match each other corresponds to information indicating whether or not the authentication has been successful. Note that the two pieces of face feature information match each other (match: yes) means a case where the degree of match is a predetermined value or greater.

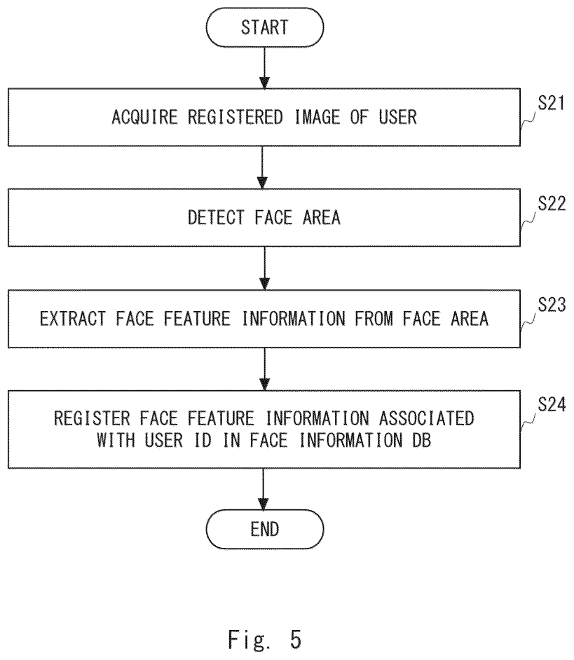

FIG. 5 is a flowchart showing a flow of face information registration processing according to the second example embodiment. First, the face authentication apparatus 100 acquires the registered image of the user included in the face registration request (S21). For example, the face authentication apparatus 100 receives, via the network N, the face registration request from the server 200 that has received the member registration request from the user terminal 300. Note that this is merely an example, and the face authentication apparatus 100 may instead receive the face registration request directly from the user terminal 300. Next, the face detection unit 120 detects a face area included in the registered image (S22). Next, the feature point extraction unit 130 extracts feature points from the face area detected in Step S22 and supplies face feature information to the registration unit 140 (S23). Last, the registration unit 140 issues a user ID 111, and registers the user ID 111 and the face feature information 112 in the face information DB 110 in such a way that they are associated with each other (S24). Note that the face authentication apparatus 100 may receive face feature information 112 from a device that has sent a face registration request and register the received face feature information 112 and the user ID 111 in the face information DB 110 in such a way that they are associated with each other.

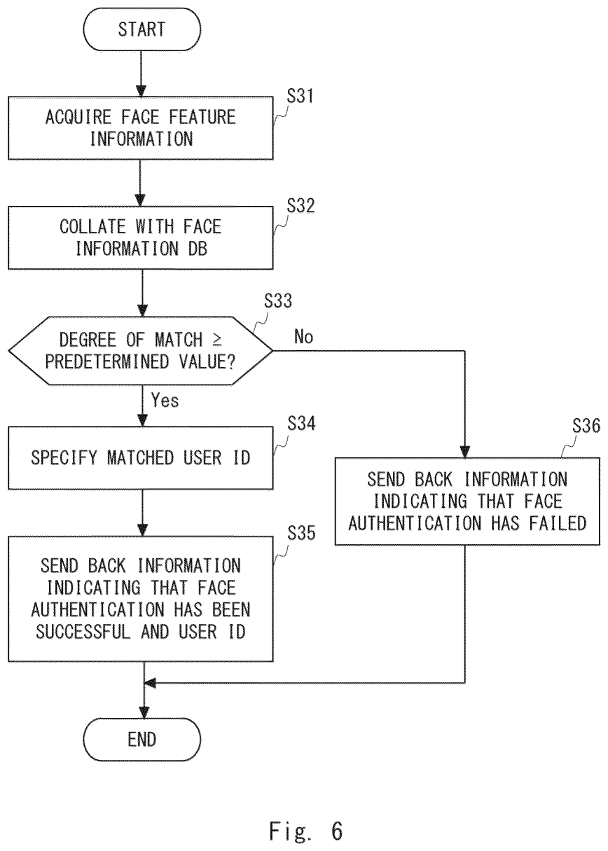

FIG. 6 is a flowchart showing a flow of face authentication processing according to the second example embodiment. First, the feature point extraction unit 130 acquires face feature information for authentication (S31). For example, the face authentication apparatus 100 receives a face authentication request from the server 200 via a network N and extracts face feature information from the face image included in the face authentication request as shown in Steps S21 to S23. Alternatively, the face authentication apparatus 100 may receive the face feature information from the server 200. Next, the authentication unit 150 collates the acquired face feature information with the face feature information 112 of the face information DB 110 (S32). When the two pieces of face feature information match each other, that is, when the degree of match of the face feature information is equal to or greater than a predetermined value (Yes in S33), the authentication unit 150 specifies the user ID 111 of the user regarding whom the face feature information has matched (S34). Then, the authentication unit 150 sends information indicating that face authentication has been successful and the specified user ID 111 back to the server 200 as a result of face authentication (S35). When there is no face feature information that match each other (No in S33), the authentication unit 150 sends information indicating that face authentication has failed back to the server 200 as the result of face authentication (S36).

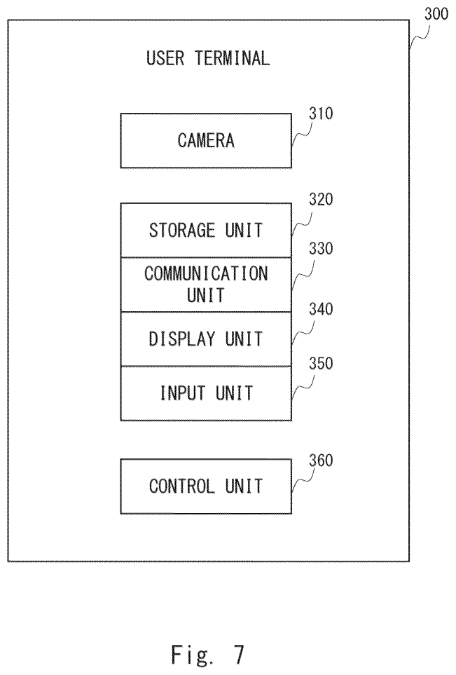

FIG. 7 is a block diagram showing a configuration of the user terminal 300 according to the second example embodiment. The user terminal 300 includes a camera 310, a storage unit 320, a communication unit 330, a display unit 340, an input unit 350, and a control unit 360.

The camera 310 is an image-capturing apparatus that captures images in accordance with control performed by the control unit 360. The storage unit 320 is a storage apparatus storing a program for implementing each function of the user terminal 300. The communication unit 330 is a communication interface with the network N. The display unit 340 is a display apparatus. The input unit 350 is an input apparatus for receiving an input from the user. The display unit 340 and the input unit 350 may be integrally formed, like a touch panel. The control unit 360 performs control of hardware included in the user terminal 300.

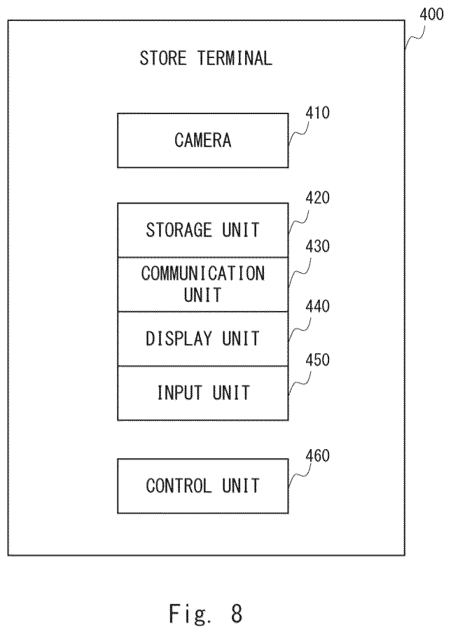

FIG. 8 is a block diagram showing a configuration of the store terminal 400 according to the second example embodiment. The store terminal 400 includes a camera 410, a storage unit 420, a communication unit 430, a display unit 440, an input unit 450, and a control unit 460.

The camera 410 is an image-capturing apparatus that captures images in accordance with control performed by the control unit 460. The storage unit 420 is a storage apparatus that stores a program for implementing each function of the store terminal 400. The communication unit 430 is a communication interface with the network N. The display unit 440 is a display apparatus. The input unit 450 is an input apparatus that receives an input. The display unit 440 and the input unit 450 may be integrally formed, like a touch panel. The control unit 460 performs control of hardware included in the store terminal 400.

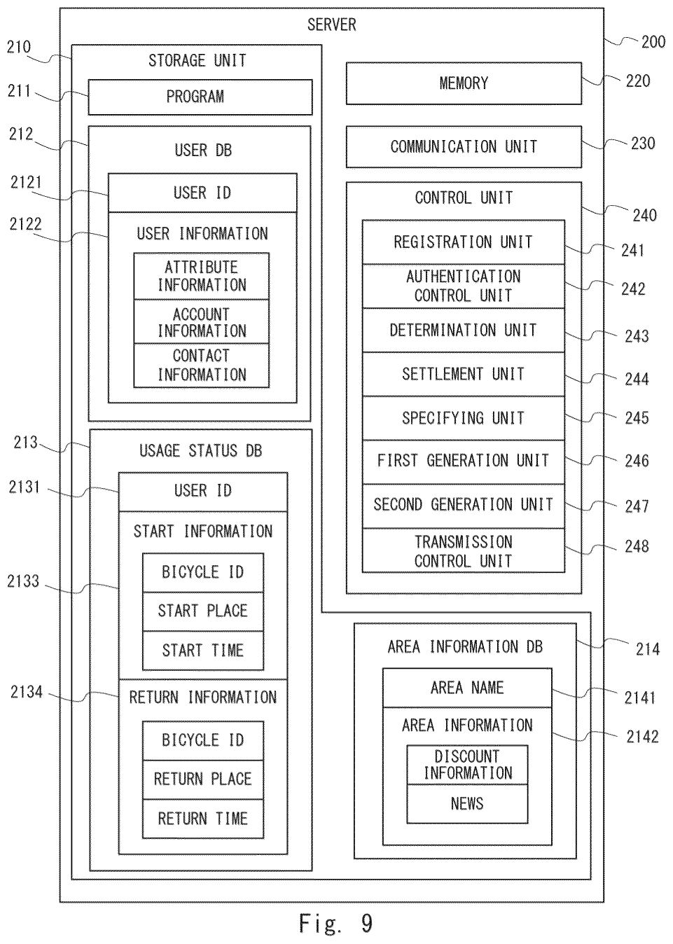

FIG. 9 is a block diagram showing a configuration of the server 200 according to the second example embodiment. The server 200 includes a storage unit 210, a memory 220, a communication unit 230, and a control unit 240.

The storage unit 210 is a storage apparatus such as a hard disc or a flash memory. The storage unit 210 stores a program 211, a user DB 212, a usage status DB 213, and an area information DB 214. The program 211 is a computer program in which processing of the information processing method according to the second example embodiment is implemented.

The user DB 212 is a database that stores user information on the user, who is a member. Specifically, the user DB 212 stores user information 2122 in association with a user ID 2121. For example, the user information 2122 includes attribute information, account information for settlement, and contact information such as a telephone number or a mail address.

The usage status DB 213 is a database that stores a usage status of a bicycle for each user. Specifically, the usage status DB 213 stores start information 2133 and return information 2134 in association with a user ID 2131 of the user who rents the bicycle.

The bicycle ID 2131 is information for identifying a bicycle. The bicycle ID 2131 is, for example, a vehicle body number or a crime prevention registration number.

The start information 2133 is information related to a rental start procedure. The start information 2133 includes a start place indicating the bicycle parking area where the start procedure has been performed and a rental start time.

The return information 2134 is information related to a procedure for returning the rented bicycle. The return information 2134 includes a return place indicating the bicycle parking area where the return procedure has been performed and a bicycle return time.

The area information DB 214 is a database that stores area information of each area. Specifically, the area information DB 214 stores area information 2142 in such a way that it is associated with an area name 2141. The area name 2141 is the name for each area. Note that the area information DB 214 may store, in place of or in addition to the area name 2141, information on the longitude and the latitude or other geographical information for each area. The area information 2142 includes discount information of stores operating in the area, and news such as the weather, traffic information, or event information in this area.

The memory 220 is a volatile storage apparatus such as a Random Access Memory (RAM), and is a storage area for temporarily holding information when the control unit 240 operates. The communication unit 230 is a communication interface with the network N.

The control unit 240 is a processor that controls each configuration of the server 200, that is, a control apparatus. The control unit 240 causes the memory 220 to load the program 211 from the storage unit 210 to execute the program 211. Accordingly, the control unit 240 implements functions of a registration unit 241, an authentication control unit 242, a determination unit 243, a settlement unit 244, a specifying unit 245, a first generation unit 246, a second generation unit 247, and a transmission control unit 248.

The registration unit 241 is also referred to as registration means. The registration unit 241 transmits, when the communication unit 230 has received a member registration request including a registered image from the user terminal 300, a face registration request to the face authentication apparatus 100. Then the registration unit 241 receives an issued user ID from the face authentication apparatus 100 in which the face feature information is registered. Further, the registration unit 241 receives user information from the user terminal 300, and registers the issued user ID and the user information in the user DB 212 in such a way that they are associated with each other.

The authentication control unit 242 is also referred to as authentication control means. The authentication control unit 242 specifies the user ID of the user by controlling face authentication based on the face image. Specifically, the authentication control unit 242 transmits, upon receiving a request for completing a start procedure or a return procedure including a face image from the store terminal 400, a face authentication request including the face image or face feature information extracted from the face image to the face authentication apparatus 100 via the network N. Then the authentication control unit 242 acquires the result of face authentication from the face authentication apparatus 100. When the face authentication has been successful, the authentication control unit 242 retrieves the user ID from the result of face authentication.

Note that the request for completing the start procedure may include, besides the face image, start information. Further, the request for completing the return procedure may include, besides a face image, return information.

The determination unit 243 is one example of the determination unit 13 according to the first example embodiment. The determination unit 243 determines, when face authentication performed in response to a request for completing the start procedure has been successful, that the start procedure has been completed. Further, the determination unit 243 determines, when face authentication performed in response to a request for completing the return procedure has been successful, that the return procedure has been completed. The determination unit 243 supplies the result of the determination to the specifying unit 245.

The settlement unit 244 is also referred to as settlement means. In this second example embodiment, the settlement unit 244 determines, upon determining by the determination unit 243 that the return procedure has been completed, a rental time based on the start time and the return time, and determines the amount to be paid. Then the settlement unit 244 performs settlement using the account information associated with the user ID retrieved from the result of face authentication. Note that the determination of the amount to be settled and the settlement may be performed by the settlement unit 244 before the determination of completion of the return procedure or may be performed in parallel to the determination.

The specifying unit 245 specifies, upon determining by the determination unit 243 that the start procedure has been completed, the start place, which is a bicycle parking area where the start procedure has been performed. Further, the specifying unit 245 specifies, upon determining by the determination unit 243 that the return procedure has been completed, the return place, which is a bicycle parking area where the return procedure has been performed.

The specification of the start place or the return place may be performed, for example, by the following method. Alternatively, the specification may be performed by another known method.
(1) The specifying unit 245 may specify the ID of the store terminal 400 that has sent a request for completing the start procedure or the return procedure, and specify the start place or the return place for the bicycle based on identification information of the store terminal 400. As one example, the ID of the store terminal 400 is an IP address (Internet Protocol).
(2) When a communication apparatus including a GPS receiver is installed in the bicycle, the specifying unit 245 may receive location information of the bicycle from the communication apparatus and specify the start place or the return place for the bicycle based on the location information of the bicycle.
(3) The specifying unit 245 may receive, from the user terminal 300 of the user who has been successful in face authentication, location information of the user terminal 300, and specify the start place or the return place for the bicycle based on the location information of the user terminal 300.

Then the specifying unit 245 registers, when it has specified the start place or the return place, the specified start place or return place in association with the user. Specifically, the specifying unit 245 includes the specified start place or return place in start information or return information included in a procedure completion request, and registers this information in the usage status DB 213 in such a way that it is associated with the user ID.

Note that the specifying unit 245 specifies, when it has specified the return place, the area to which the specified return place belongs.

The first generation unit 246 is also referred to as first generation means. The first generation unit 246 generates, upon specifying the return place in response to the request for completing the return procedure, first transmission information for a user who has completed the return procedure.

Specifically, first, the first generation unit 246 reads out area information that corresponds to the area to which the return place belongs from the area information DB 214. Then the first generation unit 246 uses the area information that has been read out as the first transmission information or generates first transmission information based on the area information that has been read out. More specifically, the first generation unit 246 may select, based on at least one of a time zone of a return time, a rental time of the bicycle, and information on a user's schedule after a return time, the first transmission information from the area information that has been read out. The rental time is a time of use from the start time to the return time. The first generation unit 246 may be associated with a scheduler application of the user via an Application Programming Interface (API) or the like, and acquire schedule information from this application. Alternatively, the first generation unit 246 may hold a behavior history of the user, predicts the schedule from the behavior history, and use it as schedule information.

The second generation unit 247 is also referred to as second generation means. The second generation unit 247 generates, for each of the users, the second transmission information regardless of the timing when the return procedure is completed. Specifically, the second generation unit 247 specifies, for each user, the return place that is frequently used based on the history of the return place associated with the user. The phrase “frequently used” indicates that the number of times per unit period is a predetermined number of times or more. More specifically, the second generation unit 247 collects the return information associated with the user ID of the usage status DB 213, and specifies the return place where the frequency of returns is a predetermined number of times or more among the return places included in the return information.

Then the second generation unit 247 generates second transmission information based on the area information of the area to which the return place that is frequently used belongs. Specifically, first, the second generation unit 247 reads out area information corresponding to the area to which the return place that is frequently used belongs from the area information DB 214. Then the second generation unit 247 may use the area information that has been read out as the second transmission information. Alternatively, the second generation unit 247 may analyze, from a past history, a trend of at least one of the time zone of the return time, the rental time of the bicycle, and information on the user's schedule after the return time, and select, based on the result of the analysis, the second transmission information from the area information that has been read out.

The transmission control unit 248 transmits, in response to the first generation unit 246 generating the first transmission information, the first transmission information to the user terminal 300 of the user who has completed the return procedure. Further, the transmission control unit 248 transmits, in response to the second generation unit 247 generating the second transmission information, the second transmission information to the user terminal 300 of the target user.

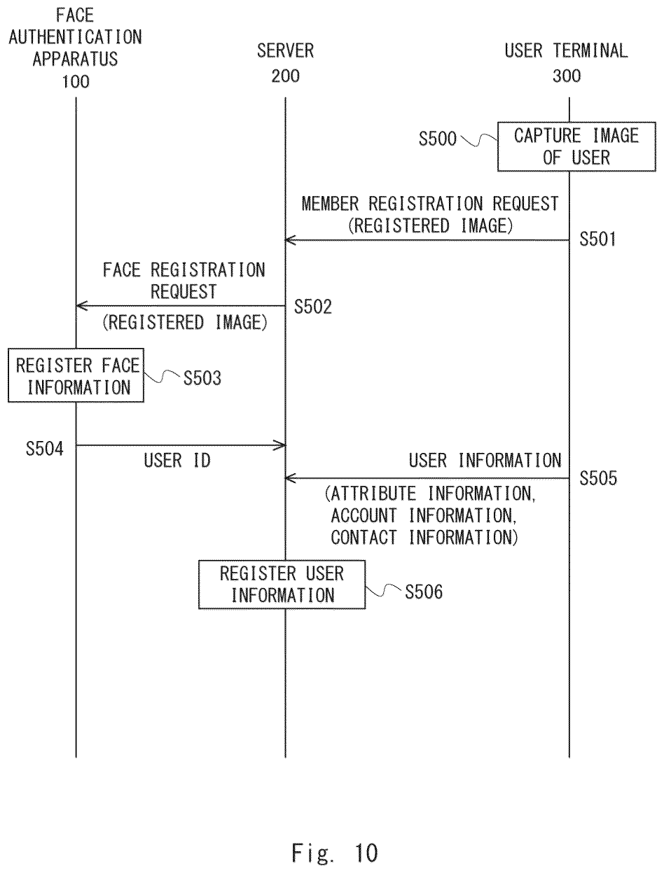

FIG. 10 is a sequence diagram showing a flow of member registration processing according to the second example embodiment. First, the user terminal 300 captures an image of the user U (S500), includes the registered image generated by image capturing in a member registration request, and transmits the obtained member registration request to the server 200 (S501). Then, the registration unit 241 of the server 200 includes the registered image included in the received member registration request in the face registration request, and transmits the obtained face registration request to the face authentication apparatus 100 (S502). Then, the face authentication apparatus 100 registers the face information (face feature information) of the user U based on the registered image included in the received face registration request (S503). Then the face authentication apparatus 100 sends the server 200 of the issued user ID (S504). Further, the user terminal 300 transmits the user information to the server 200 (S505). At this time, the user information may include attribute information, account information, and contact information. The registration unit 241 of the server 200 registers the user ID and the user information that have been sent in the user DB 212 in such a way that they are associated with each other (S506).

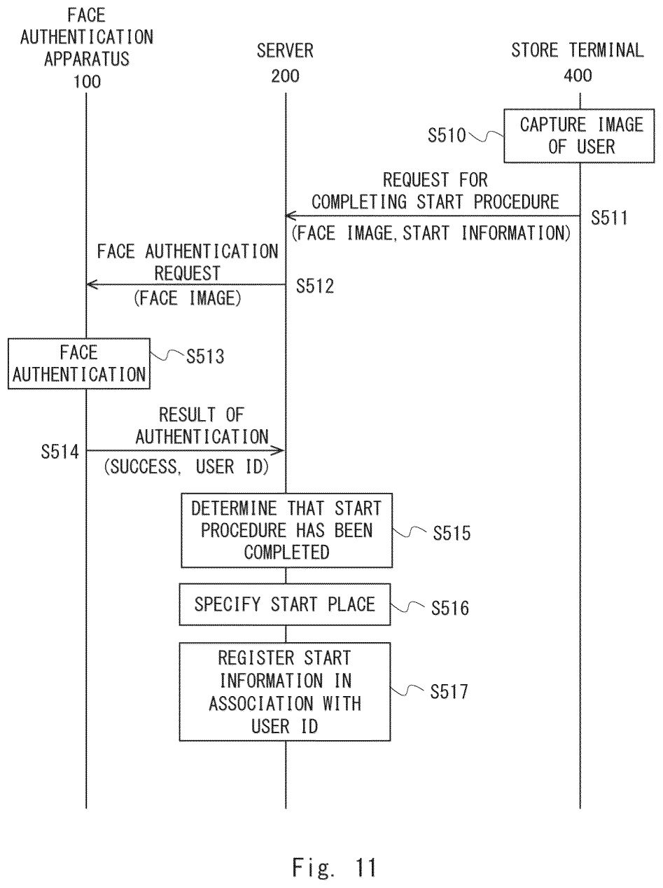

FIG. 11 is a sequence diagram showing a flow of rental start processing according to the second example embodiment. First, the store terminal 400 captures an image of the user upon receiving an input for requesting a bicycle rental start procedure in a bicycle parking area from the user (S510). Then the store terminal 400 includes the face image generated by image capturing and the start information in the request for completing the start procedure, and transmits this request to the server 200 (S511). The start information at least includes a bicycle ID of a bicycle for rental, and a start time.

The authentication control unit 242 of the server 200 transmits a face authentication request for the face area of the user U in the face image included in the completion request to the face authentication apparatus 100 (S512). Then the face authentication apparatus 100 performs face authentication on the face area of the user U in the face image included in the received face authentication request (S513). It is assumed here that there is a user ID that has been successful in face authentication. The face authentication apparatus 100 transmits the result of face authentication including information indicating that face authentication has been successful and the user ID to the server 200 (S514). At this time, the server 200 may notify the store terminal 400 of information indicating whether or not face authentication has been successful.

The determination unit 243 of the server 200 which has received the result of face authentication determines that the start procedure has been completed (S515).

Next, the specifying unit 245 specifies the ID of the store terminal 400 that has sent a request for completing the start procedure, and specifies the start place of the bicycle based on the ID of the store terminal 400 (S516). The specifying unit 245 includes the start place in the start information included in the completion request, and registers the start information in the usage status DB 213 in such a way that it is associated with the user ID (S517).

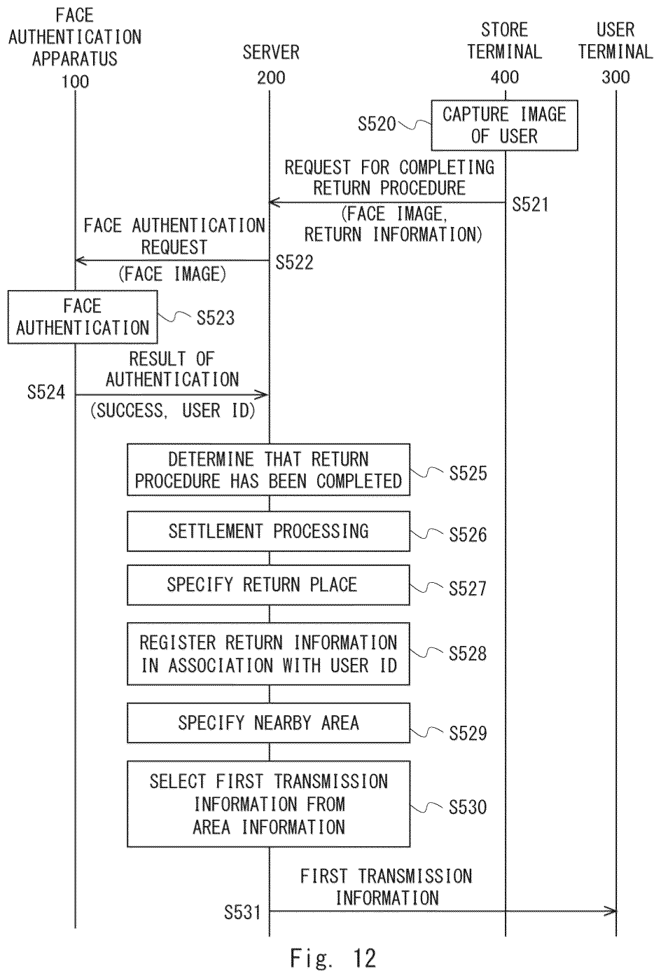

FIG. 12 is a sequence diagram showing a flow of return processing according to the second example embodiment. First, the store terminal 400 captures an image of a user upon acquiring, from a sensor of a tire holder, that detection information indicating that a bicycle tire has been inserted into a tire holder in a bicycle parking area and receiving, from the user, an input for requesting a bicycle return procedure (S520). Then, the store terminal 400 includes the face image generated by image capturing and the return information in a request for completing the return procedure and transmits the request to the server 200 (S521). The return information at least includes the bicycle ID of the bicycle for rental and the return time.

The authentication control unit 242 of the server 200 transmits a face authentication request for the face area of the user U in the face image included in the completion request to the face authentication apparatus 100 (S522). Then the face authentication apparatus 100 performs face authentication regarding the face area of the user U in the face image included in the received face authentication request (S523). It is assumed here that there is a user ID that has been successful in face authentication. The face authentication apparatus 100 transmits the result of face authentication including information indicating that face authentication has been successful and the user ID to the server 200 (S524). At this time, the server 200 may notify the store terminal 400 of information indicating whether or not face authentication has been successful.

The determination unit 243 of the server 200 that has received the result of face authentication determines that the return procedure has been completed (S525). Then the settlement unit 244 determines a rental time based on the start time and the return time and performs settlement using the account information (S526).

Next, the specifying unit 245 specifies the ID of the store terminal 400 that has sent a request for completing the return procedure, and specifies the return place for the bicycle based on the ID of the store terminal 400 (S527). The specifying unit 245 includes a return place in the return information included in the completion request, and registers the return information in the usage status DB 213 in such a way that it is associated with the user ID (S528).

Next, the specifying unit 245 specifies the area (nearby area) to which the specified return place belongs (S529). Then the first generation unit 246 generates first transmission information for the user who has completed the return procedure from the area information of the nearby area stored in the area information DB 214 (S530). Last, the transmission control unit 248 transmits the first transmission information to the user terminal 300 of the user who has completed the return procedure (S531).

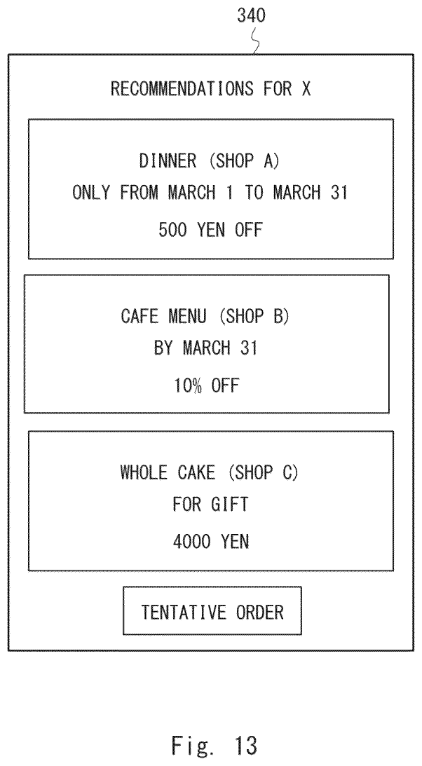

FIG. 13 is a diagram showing one example of display of the user terminal 300 according to the second example embodiment. The display unit 340 displays, as the first transmission information, discount information or other sales promotion information in recommended stores near the return place of the user X. When, for example, the time zone of the return time is in the evening, the first transmission information may include discount information of dinners offered by nearby stores. Further, when the user X has used a rental service a predetermined period of time or longer, the first transmission information may include discount information of a menu suitable for a break offered by, for example, a nearby cafe. Further, when, for example, the user X is going to join a home party held at his/her friend's house after the return time, the first transmission information may include sales promotion information of a gift-worthy product offered by a nearby store.

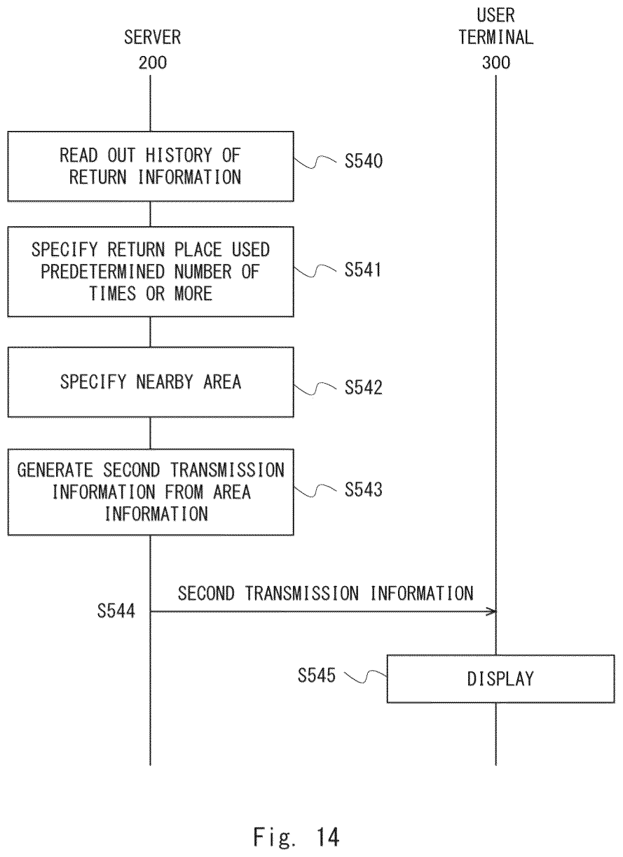

FIG. 14 is a sequence diagram showing a flow of processing for providing the second transmission information according to the second example embodiment. The second generation unit 247 of the server 200 performs processing for providing the second transmission information for each user. For example, the second generation unit 247 may perform processing for providing the second transmission information only for users whose rental time, usage fee, and frequency of usage satisfy predetermined criteria. Further, the second generation unit 247 may perform the above processing regularly, for example, regardless of the timing of the return.

First, the second generation unit 247 reads out the history of return information associated with the user ID of the user in the usage status DB 213 (S540). Then the second generation unit 247 counts up the return places from the history of the return information that has been read out and specifies the return place used by this user a predetermined number of times or more (S541). Then the second generation unit 247 specifies the area near the return place (S542). The second generation unit 247 reads out the area information of the nearby area from the area information DB 214, and generates second transmission information based on the area information (S543). Then the second generation unit 247 transmits the second transmission information to the user terminal 300 of the user (S544). The user terminal 300 that has received the second transmission information displays the second transmission information on the display unit 340 (S545).

As described above, according to the second example embodiment, the server 200 gives an advantage to the user by transmitting the first transmission information to the user terminal 300 of the user who has completed the return procedure and transmitting the second transmission information to the user who uses the service. As a result, it is possible to promote repeated use of the rental service. When, in particular, the user tends to use a certain place as the destination, the server 200 transmits second transmission information, whereby it is possible to efficiently promote repeated use of a rental service as transportation for the destination.

Further, the server 200 may let the user who has completed the return procedure travel around the return place when it has transmitted the first transmission information or the second transmission information. As a result, it is possible to contribute to revitalization of the local economy.

Note that the present disclosure is not limited to the aforementioned example embodiments and may be changed as appropriate without departing from the spirit of the present disclosure. For example, while the face authentication apparatus 100 executes face authentication in the information processing system 1000 according to the second example embodiment, a function of face authentication may be implemented in the server 200 and the server 200 may execute face authentication.

Further, for example, in the aforementioned second example embodiment, the store terminal 400 transmits the return information upon acquiring detection information of a sensor of a tire holder and receiving, from a user, an input for requesting a bicycle return procedure. However, the trigger for the store terminal 400 to transmit the return information is not limited to it. For example, the store terminal 400 may transmit the return information when it receives an input for requesting a bicycle ID and a return procedure from the user or when the user has appeared in front of the store terminal 400 within a predetermined time since acquisition of detection information of the sensor of the tire holder.

Further, the transmission of the return information may be performed by the user terminal 300, not by the store terminal 400. It is assumed, for example, that a QR code (registered trademark) indicating a bicycle ID is attached to the bicycle. The user reads the QR code using the user terminal 300 at the time of return, and enters a request for a return procedure into the user terminal 300. The user terminal 300 may transmit return information to the server 200 upon reading the bicycle ID, and receiving the input of the request for completing the return procedure. When the user terminal 300 transmits return information, the server 200 may acquire location information of the user terminal 300 from the user terminal 300 and specify the return place based on the location information of the user terminal 300.

Further, in the aforementioned second example embodiment, in order for the determination unit 243 to determine that the return procedure is completed, it is required that the face authentication performed in response to a request for completing the return procedure has been successful. However, the requirement of determining the completion of the return procedure is not limited to it and various forms may be employed.

When, for example, biometric authentication other than face authentication has been successful, the determination unit 243 may determine that the return procedure has been completed. In this case, the information processing system 1000 may include, in place of or in addition to the face authentication apparatus 100, a biometric authentication apparatus configured to execute other biometric authentication, or another biometric authentication function may be implemented in the server 200.

Alternatively, the face authentication may be omitted, and the determination unit 243 may determine that the return procedure has been completed upon receiving return information including a bicycle ID from the store terminal 400.

Alternatively, the determination unit 243 may determine that the return procedure has been completed upon receiving return information including a bicycle ID from the user terminal 300, not from the store terminal 400.

Alternatively, the determination unit 243 may determine that the return procedure has been completed when the determination unit 243 has received return information from both the user terminal 300 and the store terminal 400. In this case, as one example, the store terminal 400 may transmit return information including an ID of a tire holder when the store terminal 400 has received detection information indicating that a bicycle tire has been inserted into a tire holder from a sensor of the tire holder. On the other hand, the user terminal 300 may transmit return information upon receiving an input of a request for completing the return procedure including an ID of a tire holder and a bicycle ID from the user. The determination unit 243 may integrate the return information received from both of them and determine that the return procedure has been completed.

Further, the determination unit 243 may determine that the return procedure has been completed when it has received return information from both of them and biometric authentication of the user has been successful.

While the determination as to whether or not the return procedure is completed has been described above, the same is applicable to the determination as to whether or not the start procedure is completed.

Further, in the aforementioned second example embodiment, the second generation unit 247 generates second transmission information based on area information of an area to which a return place that is frequently used belongs. However, the area based on which the second transmission information is generated is not limited to the return place that is frequently used and instead may be a start place that is frequently used or may be a place that the user frequently stops during the rental of the bicycle. With this configuration as well, it is possible to suitably encourage repeated use of a rental service.

Note that the present disclosure may achieve desired processing by causing a processor to execute a computer program.

In the aforementioned examples, the program includes instructions (or software codes) that, when loaded into a computer, cause the computer to perform one or more of the functions described in the embodiments. The program may be stored in a non-transitory computer readable medium or a tangible storage medium. By way of example, and not a limitation, computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray (registered trademark) disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

### REFERENCE SIGNS LIST

10 INFORMATION PROCESSING APPARATUS
13 DETERMINATION UNIT
15 SPECIFYING UNIT
17 TRANSMISSION CONTROL UNIT
100 FACE AUTHENTICATION APPARATUS
110 FACE INFORMATION DB
111 USER ID
112 FACE FEATURE INFORMATION
120 FACE DETECTION UNIT
130 FEATURE POINT EXTRACTION UNIT
140 REGISTRATION UNIT
150 AUTHENTICATION UNIT
200 INFORMATION PROCESSING APPARATUS (SERVER)
210 STORAGE UNIT
211 PROGRAM
212 USER DB
2121 USER ID
2122 USER INFORMATION
213 USAGE STATUS DB
2131 USER ID
2133 START INFORMATION
2134 RETURN INFORMATION
214 AREA INFORMATION DB
2141 AREA NAME
2142 AREA INFORMATION
220 MEMORY
230 COMMUNICATION UNIT
240 CONTROL UNIT
241 REGISTRATION UNIT
242 AUTHENTICATION CONTROL UNIT
243 DETERMINATION UNIT
244 SETTLEMENT UNIT
245 SPECIFYING UNIT
246 FIRST GENERATION UNIT
247 SECOND GENERATION UNIT
248 TRANSMISSION CONTROL UNIT
300 USER TERMINAL
310 CAMERA
320 STORAGE UNIT
330 COMMUNICATION UNIT
340 DISPLAY UNIT
350 INPUT UNIT
360 CONTROL UNIT
400 STORE TERMINAL
410 CAMERA
420 STORAGE UNIT
430 COMMUNICATION UNIT
440 DISPLAY UNIT
450 INPUT UNIT
460 CONTROL UNIT
1000 INFORMATION PROCESSING SYSTEM

What is claimed is:

1. An information processing apparatus comprising:
at least one memory storing instructions, and
at least one processor configured to execute the instructions to:
determine whether or not a return procedure for a mobile body rented by a user has been completed;
specify upon determining that the return procedure has been completed, a return place for the mobile body; and
transmit to a user terminal used by the user, at least a part of area information regarding an area to which the specified return place belongs as first transmission information.

2. The information processing apparatus according to claim 1, wherein the at least one processor is configured to execute the instructions to select the first transmission information from the area information based on at least one of information on a user's schedule after a return time, a time zone of the return time, and a rental time of the mobile body.

3. The information processing apparatus according to claim 1, wherein
the at least one processor is configured to execute the instructions to:
register the specified return place in such a way that it is associated with the user,
specify based on a history of the return place associated with the user, a return place where a frequency of returns is a predetermined number of times or more, and generating second transmission information from area information regarding an area to which the specified return place belongs, and
transmit the second transmission information to the user terminal.

4. The information processing apparatus according to claim 1, wherein the at least one processor is configured to execute the instructions to determine that the return procedure has been completed when the determination means has received return information including identification information of the mobile body from at least one of the user terminal or a terminal in the return place.

5. The information processing apparatus according to claim 1, wherein the at least one processor is configured to execute the instructions to determine that the return procedure has been completed when the at least one processor has received return information from at least one of the user terminal or a terminal in the return place and biometric authentication of the user has been successful.

6. An information processing system comprising:
an information terminal; and
an information processing apparatus, wherein
the information processing apparatus comprises:
at least one memory storing instructions, and
at least one processor configured to execute the instructions to:
determine upon receiving return information including identification information of a mobile body rented by a user from the information terminal, whether or not a return procedure for the mobile body has been completed;
specify upon determining that the return procedure has been completed, a return place for the mobile body; and
transmit to a user terminal used by the user, at least one of area information regarding an area to which the specified return place belongs as first transmission information.

7. The information processing system according to claim 6, further comprising a biometric authentication apparatus configured to execute biometric authentication, wherein
the at least one processor is configured to execute the instructions to:
request, upon receiving the return information and biometric information of the user from the information terminal, biometric authentication based on the biometric information for the biometric authentication apparatus, and
determine that the return procedure has been completed upon acquiring a result of biometric authentication indicating that the biometric authentication has been successful from the biometric authentication apparatus.

8. An information processing method comprising:
determining whether or not a return procedure for a mobile body rented by a user has been completed;
specifying a return place for the mobile body upon determining that the return procedure has been completed; and
transmitting, to a user terminal used by the user, at least a part of area information regarding an area to which the specified return place belongs as first transmission information.

9. (canceled)
